(19) United States
(12) Patent Application Publication
(10) Pub. No.: US 2007/0230733 A1
(43) Pub. Date: Oct. 4, 2007

(54) Immulination device assembly adapted for use with a portable rechargable audio playback device

(75) Inventor: Duan-Cheng Hsieh, Taipei City (TW)

Correspondence Address: MCNEES WALLACE & NURICK LLC, 100 PINE STREET, P.O. BOX 1166, HARRISBURG, PA, 17108-1166, US

(73) Assignee: HABITEX CORPORATION, Taipei City (TW)

(21) Appl. No.: 11/378,038

(22) Filed: Mar. 17, 2006

(51) Int. Cl. H04R 1/02

(52) U.S. Cl. 381/336; 381/334

(57) ABSTRACT

An illumination device assembly includes: a circuit unit disposed in a hollow base and including a control circuit connected electrically to a lighting unit and a loudspeaker unit so as to control activation thereof in response to operation of an operating unit mounted on the base; and a power module connected electrically to the control circuit and connected electrically to an external power source so as to supply electric power to the control circuit. When a portable rechargeable audio playback device is coupled electrically to the illumination device assembly via a transmission unit, the control circuit receives audio signals from the audio playback device via the transmission unit, enables the loudspeaker unit to reproduce the audio signals, and enables a charging circuit to charge the audio playback device via the transmission unit.

### BACKGROUND OF THE INVENTION

1. Field of the Invention

The invention relates to an illumination device, more particularly to an illumination device assembly adapted for use with a portable rechargeable audio playback device.

2. Description of the Related Art

At present, a portable audio playback device, such as an MP3 player, is usually used with an earphone. Alternatively, audio signals from the portable audio playback device can also be reproduced by an external loudspeaker unit, which is connected electrically to the portable audio playback device by electrical wires.

Moreover, when the portable audio playback device is used with the external loudspeaker unit for a long period of time, it is necessary to charge the portable audio playback device through an external power source for ensuring adequate electric power during playback. As a result, electrical wires interconnecting electrically the portable audio playback device, the external loudspeaker unit and the external power source easily result in wire entanglement during use.

### SUMMARY OF THE INVENTION

Therefore, the object of the present invention is to provide an illumination device assembly that can provide audio reproduction and charging functions when used with a portable rechargeable audio playback device.

According to the present invention, there is provided an illumination device assembly adapted for use with a portable rechargeable audio playback device. The illumination device assembly comprises:
a hollow base;
a lighting unit;
a loudspeaker unit;
a circuit unit disposed in the base and including
   a control circuit connected electrically to the lighting unit and the loudspeaker unit so as to control activation thereof, and
   a charging circuit connected electrically to the control circuit;
a power module connected electrically to the control circuit of the circuit unit and adapted to be connected electrically to an external power source so as to supply electric power to the control circuit of the circuit unit;
a transmission unit mounted on the base, connected electrically to the circuit unit, and adapted to be coupled electrically to the rechargeable audio playback device; and
an operating unit mounted on the base and connected electrically to the control circuit of the circuit unit, the operating unit being operable so as to enable the control circuit of the circuit unit to activate the lighting unit and the loudspeaker unit.

When the audio playback device is coupled electrically to the transmission unit, the control circuit of the circuit unit is adapted to receive audio signals from the audio playback device via the transmission unit, enables the loudspeaker unit to reproduce the audio signals, and enables the charging circuit to charge the audio playback device via the transmission unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view showing the first preferred embodiment of an illumination device assembly according to the present invention;

FIG. 2 is a schematic circuit block diagram of the first preferred embodiment; and

FIG. 3 is a perspective view showing the second preferred embodiment of an illumination device assembly according to the present invention.

### DETAILED DESCRIPTION OF THE PREFERRED EMBODIMENTS

Before the present invention is described in greater detail, it should be noted that like elements are denoted by the same reference numerals throughout the disclosure.

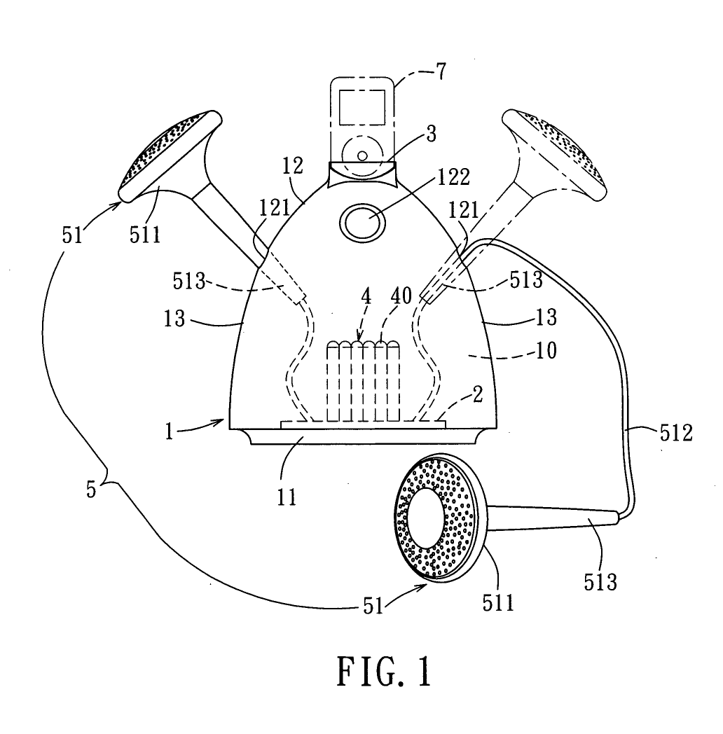

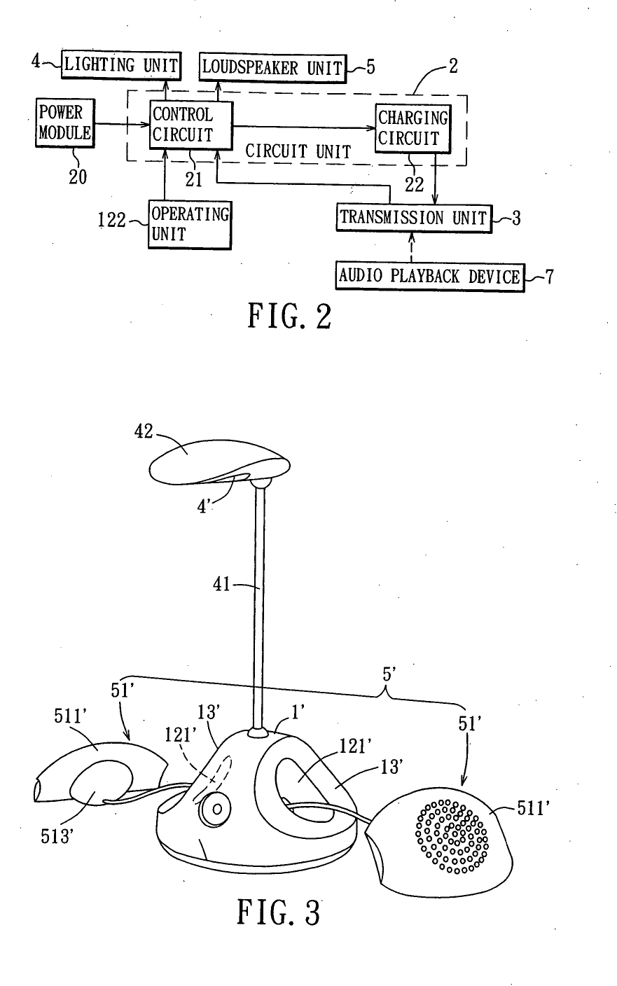

Referring to FIGS. 1 and 2, the first preferred embodiment of an illumination device assembly according to the present invention is shown to be adapted for use with a portable rechargeable audio playback device 7, such as an ipod® player. The illumination device assembly includes a hollow base 1, a lighting unit 4, a loudspeaker unit 5, a circuit unit 2, a power module 20, a transmission unit 3, and an operating unit 122.

In this embodiment, as shown in FIG. 1, the base 1 has a bottom wall 11, and a top cover 12 mounted on and cooperating with the bottom wall 11 so as to define an accommodating space 10. The top cover 12 is made of a transparent material, such as glass, and has opposite lateral sides 13, each of which is formed with an opening 121 in spatial communication with the accommodating space 10.

In this embodiment, the lighting unit 4 is disposed in the base 1 and between the bottom wall 11 and the top cover 12, and includes a plurality of light emitting diodes 40.

In this embodiment, the loudspeaker unit 5 includes a pair of loudspeakers 51. Each loudspeaker 51 has a loudspeaker housing 511 that has an engaging portion 513 extending into the accommodating space 10 in the base 1 via the opening 121 in a respective one of the lateral sides 13 of the top cover 12 of the base 1 and engaging detachably the opening 121 in the respective one of the lateral sides 13 of the top cover 12 of the base 1.

The circuit unit 2 is disposed in the base 1, and includes a control circuit 21 and a charging circuit 22. The control circuit 21 is connected electrically to the lighting unit 4 and the loudspeaker unit 5 so as to control activation thereof. The charging circuit 22 is connected electrically to the control circuit 21.

The power module 20 is connected electrically to the control circuit 21 of the circuit unit 2, and is adapted to be connected electrically to an external power source (not shown) so as to supply electric power to the control circuit 21 of the circuit unit 2.

The transmission unit 3 is mounted on the top cover 12 of the base 1, is connected electrically to the control circuit 21 and the charging circuit 22 of the circuit unit 2, and is adapted to be coupled electrically to the audio playback device 7.

The operating unit 122 is mounted on the top cover 12 of the base 1, and is connected electrically to the control circuit 21 of the circuit unit 2. In this embodiment, the operating unit 122 includes a control key. The operating unit 122 is operable so as to enable the control circuit 21 of the circuit unit 2 to activate the lighting unit 4 and the loudspeaker unit 5.

When the audio playback device 7 is coupled electrically to the transmission unit 3, the control circuit 21 of the circuit unit 2 is adapted to receive audio signals from the audio playback device 7 via the transmission unit 3, enables the loudspeaker unit 5 to reproduce the audio signals, and enables the charging circuit 22 to charge the audio playback device 7 via the transmission unit 3.

FIG. 3 illustrates the second preferred embodiment of an illumination device assembly according to this invention, which is a modification of the first preferred embodiment. Unlike the previous embodiment, the illumination device assembly further includes an upright supporting member 41 mounted rotatably on a top portion of the base 1′, and a shade member 42 connected pivotally to a top end of the supporting member 41 and mounted with the lighting unit 4′. As such, the base 1′ may be made of an opaque material. In this embodiment, the engaging portion 513′ of the loudspeaker housing 511′ of each of the loudspeakers 51′ is substantially hemispherical, and engages fittingly the opening 121′ in the respective one of the lateral sides 13′ of the base 1′.

In sum, the illumination device assembly of the present invention is integrated with illumination, charging and audio reproduction functions, thereby resulting in convenience during use. Furthermore, wire entanglement can be avoided.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An illumination device assembly adapted for use with a portable rechargeable audio playback device, comprising:
a hollow base;
a lighting unit;
a loudspeaker unit;
a circuit unit disposed in said base and including
a control circuit connected electrically to said lighting unit and said loudspeaker unit so as to control activation thereof, and
a charging circuit connected electrically to said control circuit;
a power module connected electrically to said control circuit of said circuit unit and adapted to be connected electrically to an external power source so as to supply electric power to said control circuit of said circuit unit;
a transmission unit mounted on said base, connected electrically to said circuit unit, and adapted to be coupled electrically to the audio playback device; and
an operating unit mounted on said base and connected electrically to said control circuit of said circuit unit, said operating unit being operable so as to enable said control circuit of said circuit unit to activate said lighting unit and said loudspeaker unit;
wherein, when the audio playback device is coupled electrically to said transmission unit, said control circuit of said circuit unit is adapted to receive audio signals from the audio playback device via said transmission unit, enables said loudspeaker unit to reproduce the audio signals, and enables said charging 4 circuit to charge the audio playback device via said transmission unit.

2. The illumination device assembly as claimed in claim 1, wherein said lighting unit is disposed in said base, said base having a bottom wall, and a top cover mounted on said bottom wall and made of a transparent material, said lighting unit being disposed between said bottom wall and said top cover.

3. The illumination device assembly as claimed in claim 2, wherein said lighting unit includes a plurality of light emitting diodes.

4. The illumination device assembly as claimed in claim 1, further comprising an upright supporting member mounted rotatably on a top portion of said base, and a shade member connected pivotably to a top end of said supporting member and mounted with said lighting unit.

5. The illumination device assembly as claimed in claim 1, wherein said base has opposite lateral sides, said loudspeaker unit including a pair of loudspeakers mounted detachably and respectively on said lateral sides of said base.

6. The illumination device assembly as claimed in claim 5, wherein said base is configured with an accommodating space, each of said lateral sides of said base being formed with an opening in spatial communication with said accommodating space, each of said loudspeakers of said loudspeaker unit having a loudspeaker housing that has an engaging portion extending into said accommodating space in said base via said opening in a respective one of said lateral sides of said base and engaging detachably said opening in the respective one of said lateral sides of said base.

7. The illumination device assembly as claimed in claim 6, wherein said engaging portion of said loudspeaker housing of each of said loudspeakers is substantially hemispherical, and engages fittingly said opening in the respective one of said lateral sides of said base.
